(19) United States
(12) Patent Application Publication
(10) Pub. No.: US 2009/0108486 A1
(43) Pub. Date: Apr. 30, 2009

(54) Method and apparatus for smoothening rough edges of lithographic patterns

(76) Inventor: Sergey Babin, Castro Valley, CA (US)

Correspondence Address: Sergey Babin, 5286 Danningan Ct., Castro Valley, CA, 94546, US

(21) Appl. No.: 11/977,703

(22) Filed: Oct. 26, 2007

(51) Int. Cl. B28B 11/00; C04B 40/00

(52) U.S. Cl. 264/82; 425/445

(57) ABSTRACT

A method and an apparatus for smoothening rough edges of lithographic patterns on semiconductor wafers and thus improving quality of the elements that constitute the target pattern by softening the surface layer of the rough edges to the extent at which smoothening may occur under the effect of forces of surface tension. The pattern is treated under normal pressure in the atmosphere of a phase of the aforementioned organic substance selected from vapor of an organic vapor or mist of organic substance in nitrogen or another gas. Two modes are possible: 1) direct diffusion of organic molecules into the surface layer of the pattern material; or 2) condensation onto the pattern surface with the formation of an extremely thin organic film, which also leads to diffusion of the organic molecules into the pattern material.

### FIELD OF THE INVENTION

The present invention relates to a method and an apparatus for smoothening rough edges of lithographic patterns on semiconductor wafers, which are used in the manufacture of semiconductor devices such as integrated circuits. More specifically, the invention relates to smoothening of rough edge on polymer resist patterns for improving quality of the elements that constitute the target pattern.

### BACKGROUND OF THE INVENTION

Patterns manufactured by means of micro- and nano-fabrication processes are comprised of extremely small features, the quality and placement accuracy of which are crucial for the performance of the fabricated devices. In view of the current tendency toward further miniaturization of microelements that are used in integrated circuits, the problem of quality and dimensional accuracy of patterns becomes a critical issue. This is because line width variations and line edge roughness (LER) determine key physical and technical parameters of circuits and devices as well as yield and hence the economic efficiency of a fabrication process.

LER is considered one of major problems, slowing down the progress in microlithography and, in a more general sense, in the semiconductor technology.

There exist a number of methods and systems for elimination of roughness on edges of resist micropatterns. Some examples of the aforementioned conventional methods and apparatuses are described in technical and patent literature given below.

Thus, post-develop rinse is known to improve LER smoothing (see for example, “Rinse additives for line-edge roughness control in 193-nm lithography”. By Goldfarb, Dario L.; Burns, Sean D.; Burns, Ryan L.; Brodsky, Colin J.; Lawson, Margaret C.; Angelopoulos, Marie, Advances in Resist Technology and “Processing XXI”. Edited by Sturtevant, John L. Proceedings of the SPIE, Volume 5376, pp. 343-351 (2004)).

The post-processing method is based on the ability of an additive-containing rinse to condition the surface of photoresist patterns. Organic salts added to the final rinse used to quench the development process are found to be particularly effective towards this end. LER reduction up to 15% was observed for a broad range of 193 nm resist systems, while preserving the integrity of the pattern profiles. The dependence of LER reduction on additive concentration was investigated and the limited improvement observed was explained based on the tendency of the additive to self-aggregate.

The disadvantages of this technique are associated with two major factors: (a) limited improvement due to the tendency of the rinse additives to self-aggregate, and (b) liquid film surface tension induced pattern collapse.

U.S. Pat. No. 6,764,946 issued to G. Ambard in 2004 discloses a method of controlling line edge roughness in resist films, wherein resist lines are first may be made smaller by 30-60 nm than a desired line width. Then the photo resist line is reacted with a coating to form a mask line having a line width corresponding to the desired line width of the integrated circuit line and with a smaller LER than of the originally fabricated photo resist line.

A technique described in the U.S. Pat. No. 7,064,846 issued in 2006 to G. Amblard, et al. reduces the LER by heating a particular resist to the glass transition temperature to effectuate mitigation of LER and/or standing wave expression. Additionally, by heating the resist to its glass transition temperature, the systems and methods of the aforementioned invention effectively impede deviation from a desired target critical dimension.

The use of non-lithographic shrink techniques for fabrication of imprint masks that facilitate improved critical dimension (CD) control and the reduction of line-edge roughness (LER) during pattern line formation in an imprint mask is described in U.S. Pat. No. 7,159,205 issued in 2007 to G. Amblard, et al. The line is formed larger than ultimately desired in a mask resist. Upon application of a thermal reflow shrink technique, LER is mitigated and CD is reduced to within a desired target tolerance.

Another direction known in the filed of reduction of LER is the use of plasma. Such processes and apparatuses are described in a number of patents and published patent applications some of which are given below.

For example, US Patent Application Publication No. 20070143721 published in 2007 (inventor Timothy Dalton, et al.) describes a system and method for plasma induced modification and improvement of critical dimension uniformity. Novel interconnect structures possessing an organo-silicate glass or polymeric-based (90 nm and beyond the back-of-line technologies) in which advanced plasma processing is utilized to reduce post lithographic CD non-uniformity, such as line edge roughness in semiconductor devices. The novel interconnect structure has enhanced liner and seed conformity and is therefore capable of delivering improved device performance, functionality and reliability. In the above-mentioned process, a dual frequency capacitive (DFC) plasma etch process is applied to a spin-on or CVD-type anti-reflective coating (ARC) material underlying a patterned post lithographic structure. The process comprises tailoring a plasma etch chemistry such that a significant neutral to ion flux ratio is achieved whereby a rate of chemisorption of a reactive species onto an RC material surface is greater than a rate of sputtering of volatile adsorbates from the surface thereby facilitating increased etch isotropy and resulting in reduced CD non-uniformity and uniform line width variation.

U.S. Pat. No. 7,271,106 issued in 2007 to Mirzafer Abatchev, et al. discloses a method of etching substrates with small critical dimensions and altering the critical dimensions. In one embodiment, a sulfur oxide based plasma is used to etch an amorphous carbon hard mask layer. The features of a pattern can be shrunk using a plasma etch to reduce the resist elements on the surface of the masking structure. Features in the pattern can also be enlarged by depositing polymer on the resist elements or by sloping an underlying layer. In one preferred embodiment, features of the pattern are shrunk before being enlarged in order to reduce line edge roughness.

U.S. Pat. No. 6,811,956 issued in 2004 issued to Calvin Gabriel in 2004 relates to a line edge roughness reduction by plasma treatment before etch.

One aspect of the aforementioned invention relates to a system and method for mitigating LER as it may occur on short wavelength photoresists. The method involves forming a short wavelength photoresist over a substrate having at least one dielectric layer formed thereon, exposing the photoresist to a plasma selective to the photoresist to strengthen the photoresist without substantially etching the at least one dielectric layer, the plasma comprising hydrogen, helium and argon, and etching the dielectric layer through openings of the strengthened photoresist with an etchant selective to the at least one dielectric layer, whereby the treated photoresist is substantially resistant to etching effects of the etchant. The system includes a photoresist monitor system for monitoring the plasma treatment to determine whether the photoresist has been strengthened and for adjusting parameters associated with the plasma treatment and for providing feedback to the plasma treatment system.

A disadvantage of processes based on the use of chemical solutions and thermoflow processes is that these processes and corresponding equipment do not allow smoothening to a desirable degree. Furthermore, the processes based on the use of chemical solutions are subject to segregation effects, involve a large amount of chemicals, are difficult to control, are not versatile, have no sufficient flexibility, and are associated with the formation of liquid films known to induce mechanical pattern damage.

On the other hand, a common disadvantage of all plasma-based processes is that they require the use of vacuum which is always associated with the use of expensive and complicated equipment. Furthermore, utilization of specific plasma requires use of specially-tailored equipment which is not only expensive but also inconvenient in adjustment and operation.

### OBJECTS AND SUMMARY OF THE INVENTION

It is an object of the present invention to provide a method and an apparatus for smoothening rough edges of lithographic patterns by softening the material of the edges to a degree that allows smoothening under effect of surface tension. It is another object to provide a method and apparatus which make it possible to improve quality of the pattern elements without deviations from the designed dimensions. It is another object to provide a LER reduction to a very fine degree of smoothening without deviations from the desired contours and designed dimensions of the pattern lines. A further object is to provide a process that is not subject to segregation effects, does not involve a large amount of chemicals, is easy to control, is versatile, has sufficient flexibility, and is not associated with the formation of liquid films known to induce mechanical pattern damage. It is another object of the invention to provide the aforementioned method and apparatus that do not need the use of vacuum and associated complicated equipment. It is a further object to provide an apparatus in which LER treatment, rinsing, and drying are carried out in a single working chamber.

The proposed concept utilizes post develop/rinse wafer treatment with gaseous mixture consisting of neutral carrier gas (such as nitrogen, argon) saturated with resist solvent vapors, or in another embodiment with fine aerosol. If the temperature of the wafer surface is maintained slightly higher (by about 3-10° C.) than the treating gaseous mix, then the solvent does not condense over the surface forming a liquid film, allowing treatment without having liquid film over the surface. This is the major advantage as compared with the existing methods since the method of the invention utilizes the effect of surface tension for smoothening nano-roughnesses formed on the surfaces of the microelements after conventional microlithographic processes. According to the invention, the pattern is treated under normal pressure in the atmosphere of a phase of the aforementioned organic substance selected from vapor of an organic vapor or mist of organic substance in nitrogen or another gas. Two modes are possible: 1) direct diffusion of organic molecules into the surface layer of the pattern material; or 2) condensation onto the pattern surface with the formation of an extremely thin organic film, which also leads to diffusion of the organic molecules into the pattern material. Solvent molecules, being dissolved in the upper pattern layer, provide mobility to the surface molecules assisting surface in its natural tendency to minimize surface energy by minimizing the surface area. Solid materials cannot undergo surface minimization due to rigidity, and are therefore characterized by high levels of surface energy. On the other hand, solvent molecules, which are dissolved in-between the polymer molecules, increase their mobility, while surface energy minimization drives polymer molecules to move from high points to low ones thus smoothing the surface. The solvent dissolution levels are also higher for the high surface topography spots additionally assisting their faster smoothing. Once the surface is smoothened to the required roughness, the treatment is switched to inert gas only (at the similar conditions) and assists in evaporation of the dissolved solvent.

The embodiment of this concept is simple: the wafer is blown, continuously or in pulses, under controlled temperature of a carrier gas/solvent vapor mixture that flows from a shower head or otherwise. Gas/vapor composition can be maintained constant or variable depending on optimization procedure adjusted to particular process/resist/pattern configuration.

The best solvent is the same one that was used to make the liquid resist, which normally is propylene glycol monomethyl ether acetate (PGMEA), because the resist, by definition is soluble in it, and also this solvent is known not to introduce any new chemical effects, except for the ones already known with this solvent. However, other solvents selected from ethers of the same class, such as ethyl 2-methylbutenoate, ethyl 2-butenoate, ethyl 3-methylbutanoate also can be used.

The process may be carried out at atmospheric pressure or at a slightly higher pressure such as normally used in the lithography tracks to prevent penetration of the external ambient gases into the treatment chamber. The process temperature is normally close to the solvent boiling points (BP). For the aerosol or mist version the temperature could be slightly lower than the BP to prevent aerosol evaporation, and for the vapor-carrier gas mix it could be slightly higher than the BP, to prevent vapor condensation.

### BRIEF DESCRIPTION OF THE DRAWINGS

FIG. 1 is a flow chart of a portion of the processes for the formation of a polymeric resist pattern on a semiconductor wafer that includes the process of the invention.

FIG. 2 is a detailed flow chart of the operations that occur at the Steps 3 to 5 shown in FIG. 1,

Fig. is a schematic view of the apparatus of the invention suitable for the realization only of Steps 3A to 3F, excluding Steps 4 and 5, i.e., rinsing and drying should be carried out beyond the device of FIG. 3.

FIG. 4 is a cross-sectional view of a diffuser for mixing the nitrogen with an aerosol/mist of an organic substance.

FIG. 5 is a schematic view of the apparatus of the invention according to another embodiment in which the mixture of aerosol/mist with nitrogen can be generated directly in the shower head.

FIG. 6 is a schematic view of an apparatus of the invention in which LER process, rinsing, and drying are carried out in a single working chamber.

### DETAILED DESCRIPTION OF THE INVENTION

For better understanding the principles of the present invention, it would be useful first to briefly consider a part of sequence of processes in the manufacture of a semiconductor device that may involve the use of the process and apparatus of the invention as a step of improvement.

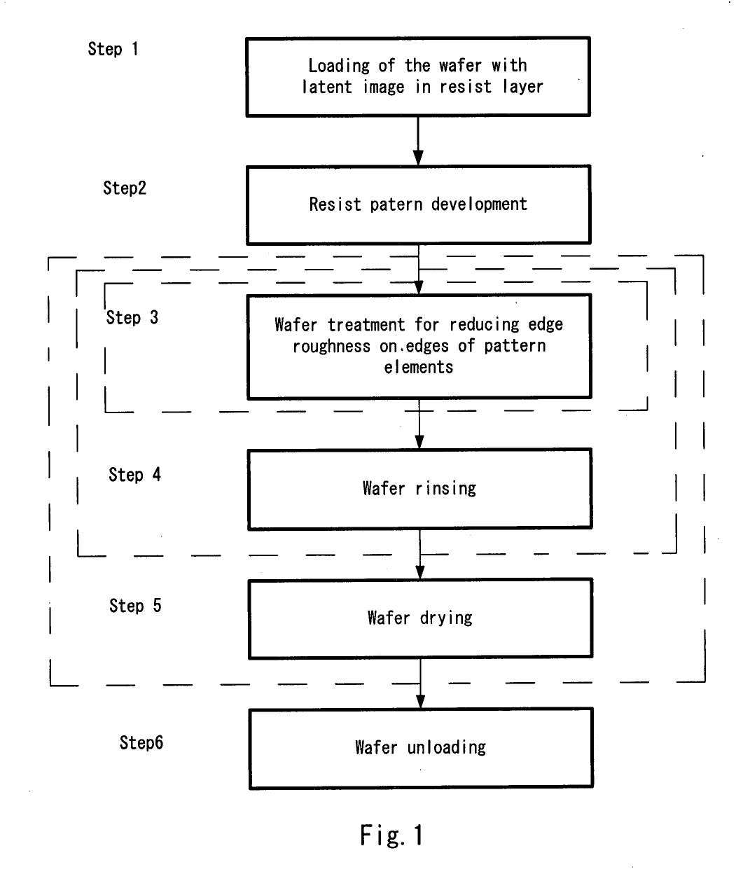

FIG. 1 is a flow chart of a portion of the processes for the formation of a polymeric resist pattern on a semiconductor wafer, e.g., after optical lithography, for example, with wavelength of 193 nm or 157 nm. In Step 1, a semiconductor wafer with a latent pattern formed in the layer of a polymeric resist is transferred to a development unit of the apparatus. After in Step 2 the latent image is developed into a relief visible pattern, the treated wafer is transferred in Step 3 to a LER unit which constitutes an apparatus of the invention. According to one embodiment, the subsequent de-ionized-water (DIW) rinsing and drying units comprise separate devices to which the wafer treated in the Step 3 is to be transferred, e.g., with the use of a separate transportation conveyor. According to another embodiment, the unit of Step 3 may combine LER with subsequent DIW rinsing in the same unit, and according to a third embodiment, the unit of Step 3 may combine LER and DIW rinsing with subsequent drying in the same unit. The apparatuses will be shown and described later, while in FIG. 1 the aforementioned combinations of the processes are shown by surrounding the respective step combinations with outlines of rectangular boxes depicted by dotted lines. The process is accomplished by unloading the wafer to the subsequent treatment which is beyond the scope of the present invention (Step 6).

Let us consider now details of the process that occurs in Steps 3 to 5.

The proposed concept utilizes post-develop/rinse wafer treatment with gaseous mixture consisting of neutral carrier gas (such as nitrogen, argon, etc.) saturated with resist solvent vapors, or in another embodiment with fine aerosol or mist. According to one mode (hereinafter the first mode) of the process, the temperature of the wafer surface is maintained slightly higher (e.g., by about 3-10° C.) than the treating gaseous mix. In this case, the solvent does not condense over the surface and does not form a liquid film, so that the process can be carried out without having liquid film over the surface.

In another mode (which hereinafter is called the second mode) the process involves condensation of the organic substance vapor onto the pattern surface with the formation of an extremely thin organic film, which is much thinner than in a conventional chemical process. In this mode, the condensation is practically discontinued on the nucleus-formation stage. This occurs when the temperature of wafer is maintained substantially the same as the temperature of the vapor. Formation of this thin film also leads to diffusion of the organic molecules into the pattern material.

Solvent molecules, being dissolved in the upper pattern layer, provide mobility to the surface molecules assisting surface in its natural tendency to minimize surface energy by minimizing the surface area. Solid materials cannot undergo surface minimization due to rigidity, and are therefore characterized by high levels of surface energy. On the other hand, solvent molecules, which are dissolved in-between the polymer molecules increase their mobility, while surface energy minimization drives polymer molecules to move from high points to low ones thus smoothing the surface. The solvent dissolution levels are also higher for the high surface topography spots additionally assisting their faster smoothing. Once the surface is smoothened to the required roughness, the treatment is switched to inert gas only (at the similar conditions) and assists in evaporation of the dissolved solvent.

The embodiment of this concept is simple: the wafer is blown, continuously or in pulses, under controlled temperature of the carrier gas/solvent vapor mix flow from a shower head or otherwise. Gas/vapor composition can be maintained constant or variable depending on optimization procedure adjusted to particular process/resist/pattern configuration.

The best solvent is the same one that was used to make the liquid resist, which normally is propylene glycol monomethyl ether acetate (PGMEA), because the resist, by definition is soluble in it, and also because this solvent is known not to introduce any new chemical effects, except for the ones already known with this solvent. However, other solvents selected from ethers of the same class, such as ethyl 2-methylbutenoate, ethyl 2-butenoate, ethyl 3-methylbutanoate also can be used.

The process may be carried out at atmospheric pressure or at a slightly higher pressure such as normally used in the lithography tracks to prevent penetration of the external ambient gases into the treatment chamber. The process temperature is normally close to the solvent boiling points (BP) at the working pressure, which are given below for the mentioned above solvents: for aerosol or mist version the temperature could be slightly lower than the BP to prevent aerosol evaporation, and for the vapor-carrier gas mix it can be slightly higher than the BP, to prevent vapor condensation.

Both modes result in softening of the surface layer of the pattern material to the level at which the force of surface tension can smoothen the softened microroughnesses similar to the effect of the surface tension on the surface of a liquid. This is the major advantage as compared to conventional microlithographic processes.

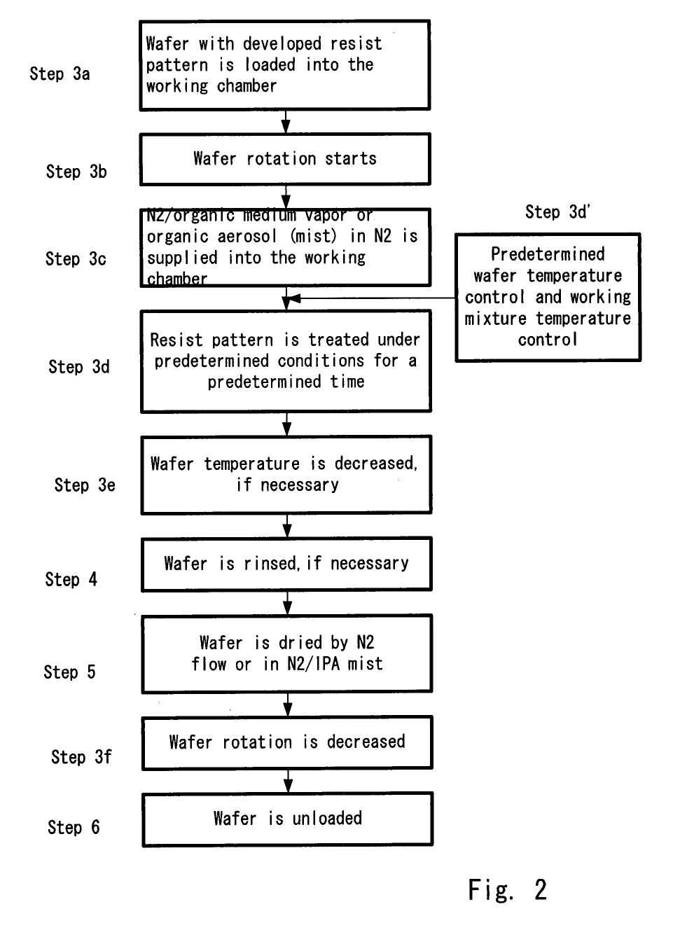

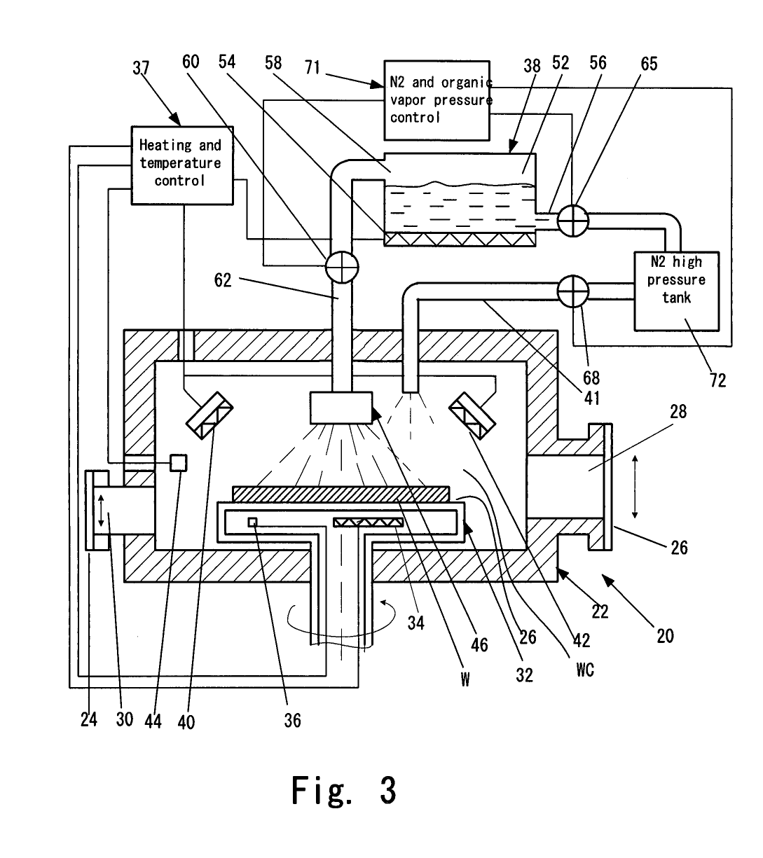

A detailed flow chart of the sequential operations that occur at the Steps 3 to 5 shown in FIG. 1 are illustrated in FIG. 2. In FIG. 2, those Steps of the process that coincide with the Steps of FIG. 1 will be designated by the same reference numerals.

In Step 3a, the wafer with developed resist pattern is loaded into the working chamber of the apparatus. The apparatus and details thereof will be describes later with reference to FIG. 3. The process can be carried out with a wafer in a stationary state or with rotation of the wafer. The rotation case is preferable since rotation provides more uniform treatment. If rotation is involved, then in Step 3b wafer begins to rotate. The speed of rotation may range, e.g., from 1 to 60 rpm. It is understood that these numbers are given only as an example. In Step 3c the working chamber is evacuated, then sealed and filled with neutral gas, e.g., N₂ under pressure slightly below the atmospheric pressure (sub-atmospheric pressure). Since the gas is supplied into the chamber under pressure slightly higher than the atmospheric pressure, this will prevent penetration of the external ambient gases into the treatment chamber. Following this, a mixture of N₂ with an organic medium vapor or a mist of the aforementioned mixture is fed to the working chamber. Next, in Step 3d a predetermined temperature control is carried out by setting the temperature of the wafer and the temperature of the medium in the working chamber to required values. The temperature is normally close to the solvent boiling point (BP) at the working pressure. For reference, the boiling points of applicable organic substances are given below:
Propylene glycol monomethyl ether acetate (pgmea)—BP 146 C
Ethyl 2-methylbutenoate—BP 115-116° C.
Ethyl 2-butenoate—BP 142.00-143.00° C.
Ethyl 3-methylbutanoate—BP 131-134° C.

For the aerosol or mist version the temperature could be slightly lower than the BP to prevent aerosol/mist evaporation, and for the vapor-carrier gas mix it could be slightly higher than the BP, to prevent vapor condensation (Mode 1).

In Step 3e the worked-out medium is removed from the working chamber through the exhaust port, and the chamber is filled with nitrogen. This process occurs practically continuously without noticeable pressure change. At the same time the wafer temperature is decreased since nitrogen arrives at a lower temperature than temperature in the working chamber.

If necessary, in Step 4 the wafer is rinsed, e.g., with de-ionized water (DI), and in Step 5 the wafer may be dried, e.g., in a flow of N₂ or in a mist of N₂ with isopropyl alcohol (IPA). If Steps 4 and 5 are optional, then in Step 3f rotation of the wafer is discontinued, and then in Step 6 the wafer is unloaded and sent to a subsequent operation, which is beyond the scope of the present invention.

FIG. 3 is a schematic view of the apparatus of the invention suitable for the realization only of Steps 3a to 3F, excluding Steps 4 and 5, i.e., rinsing and drying should be carried out beyond the device of FIG. 3.

The apparatus of the invention, which in general is designated by reference numeral 20, has a working chamber WC formed inside a housing 22, the interior of which can be sealed or unsealed by using gates 24 and 26. The gate 26 can open or close a loading/unloading port 28 through which the wafers, such as a wafer W, can be loaded and unloaded into and from the housing 22, e.g., by means of an end effector of a mechanical arm (not shown) well known in the field of semiconductor manufacturing. The gate 24 controls a gas exhaust process through a port 30 when it is required to remove the gas or mist from the working chamber. When the working chamber WC has to be sealed, the port 30 is closed by the gate 24.

The interior of the working chamber WC contains a rotatable wafer chuck 32 used for holding the wafer W in such a position that exposes the pattern of the wafer to the environment of the working chamber WC. Built into the rotating chuck 32 is a heater 34 for heating the wafer W to a required temperature and a temperature sensor 36 for detecting the current wafer temperature. The heater 34 and the temperature sensor 36 are connected to a heater/temperature control unit 37. For maintaining a given temperature in the working chamber WC, the working chamber WC is equipped with chamber environment heaters 40 and 42 which may be of any different types and in different quantities. For example only, the heaters 40 and 42 are shown as radiation-type heaters, e.g., IR radiation heaters which are connected to the heater/temperature control unit 37. A temperature sensor 44, which detects the temperature of the chamber environment, is also connected to the heater/temperature control unit 37.

Located at the top of the working chamber WC directly above the wafer-holding chuck is a shower head 46 which is intended for the supply of an organic substance vapor or an aerosol/mist of the organic substance with a neutral gas, e.g., N₂. Reference numeral 41 designates a neutral-gas supply tube, which in the illustrated embodiment is a nitrogen-supply tube to be fed into the working chamber WC as required by the pattern edge treatment procedure.

An important device of the apparatus 20 of the invention is a unit 38 (hereinafter referred to as “vapor/mist generator”) for preparation of an organic vapor or aerosol/mist . For the preparation of vapor the vapor generator 38 comprises a container 52 filled with the organic substance medium, e.g., ethyl 2-butenoate (BP: 142.00-143.00° C.) to a predetermined level in order to leave a space for the medium vapor. The container 52 is equipped with an organic-medium heater 54 capable of heating the organic medium to the boiling point, i.e., 142-143° C. In order to intensify formation of the vapor and for efficient mixing thereof with the neutral gas, such as nitrogen, the container 52 is provided with a nitrogen supply tube 56 that enters the container below the level of the liquid organic medium so that gaseous nitrogen can pass through the boiling liquid organic substance in the form of bubbles which are quickly saturated with the organic vapor and exit from the liquid to the space 58 above the boiling liquid level. In order to control pressure in the space 58, the container is equipped with an adjustable output valve 60 that may be installed in the output pipe 62 that is connected to the shower head 46. The adjustable output valve 60 is connected to a vapor/mist supply controller 37 that controls conditions (quantity, pressure, etc.) for feeding the organic medium to the working chamber WC of the apparatus 20. In other words, the controller 37 may provide a flow rate of the medium, pulsed or continuous flow, etc.

Reference numerals 65 and 68 designate nitrogen-supply valves, which are controlled through their respective controller 71. In the embodiment of the apparatus 20, the organic vapor or aerosol/mist with nitrogen is supplied to the shower head 46 from the vapor/mist generator 38 through the valve 60.

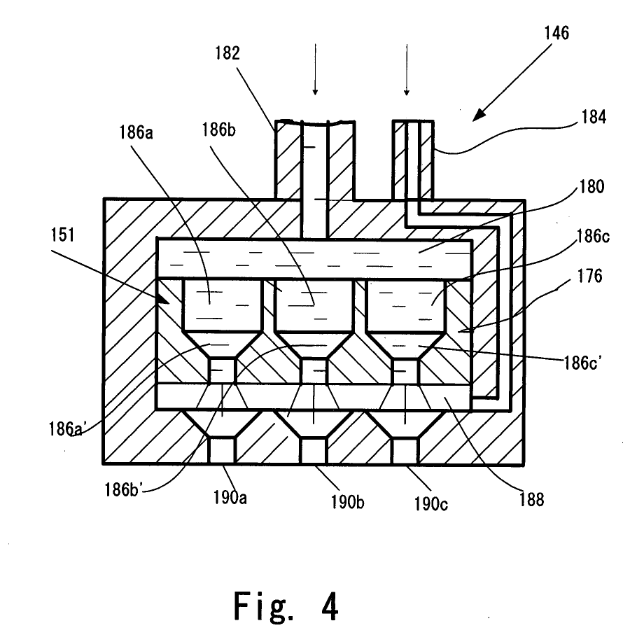

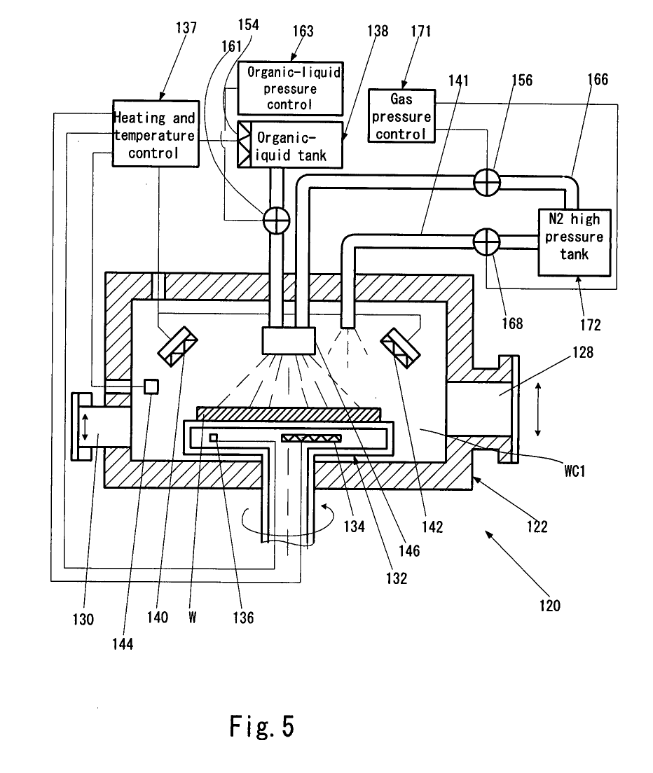

In accordance with another embodiment, which is shown in FIGS. 4 and 5, the mixture of aerosol/mist with nitrogen can be generated directly in the shower head 146. FIG. 4 is a vertical sectional view that illustrates the structure of the shower head 146 with the diffuser 151. In this case, the diffuser is located in the shower head 146.

In general, the apparatus of the embodiment of FIG. 5 is the same as one shown in FIG. 3, except that the apparatus of FIG. 5 does not contain the vapor generator and that nitrogen and the heated organic substance are supplied to the shower head where a mixture of the organic-medium vapor with nitrogen is formed. In FIG. 5 the parts of the apparatus similar to those of the apparatus of FIG. 3 are designated by the same reference numerals with an addition of 100 and their description is omitted. Thus, the apparatus is designated by reference numeral 120, the shower head is designated by reference numeral 146, etc. In FIG. 5, reference numeral 161 designates a valve that controls pressure, temperature, and other conditions of the organic medium supplied to the diffuser 151 (FIG. 4) of the shower head 146 through a controller 163. A pipe 166 supplies nitrogen directly to the diffuser 151 instead of the vapor generator which is not used in the apparatus of FIG. 5.

The shower head 146 (FIG. 4) contains a manifold 176 which has a common medium-nitrogen collector chamber 180 connected to the organic medium supply tube 182 and to a nitrogen supply tube 166.

In order to form a Bernoulli-type diffuser that facilitates suction of nitrogen into the jet flows of the organic medium emitted through the exits of the organic medium supply channels 186a through 186c, the exit ends of the aforementioned organic medium supply channels are converged to organic medium exit nozzles 186a′ through 186c′. The aforementioned exit nozzles 186a′ through 186c′ are separated by a gap 188 from shower output channels 190a though 190c, which are coaxial with the organic medium exit nozzles 186a′ through 186e′. The inputs of the shower output channels 190a though 190e are made in the form of converged funnels (not designated in FIG. 4). In fact, the organic medium exit nozzles 186a′ through 186c′ and shower output channels 190a though 190c form coaxial matrices of micro-diffusers that suck nitrogen into the flow of the organic medium and emit jets of organic medium with N₂ in the form of an aerosol or mist into the chamber WC1. In this embodiment, prior to the supply to the shower head 146, the organic medium is preheated to the temperature of the environment in the working chamber WC1 by a heater, which is not shown.

The operation of the apparatuses of both embodiments shown in FIGS. 3 and 5 is carried out in accordance with Steps 3A to 3F described with reference to FIG. 2. More specifically, a wafer W is inserted into the working chamber WC (WC1) and is secured in the chamber chuck 32 (132) and is heated to a required temperature by means of the heater 34 (134). The temperature of the wafer is controlled by means of the sensor 36 (136) via the controller 37 (137). The gas that fills the working chamber WC (WC1) is sucked out through the preliminarily opened exhaust port 30 (130). The chamber WC (WC1) is filled with nitrogen via the tube 41 (141) and is sealed. Treatment of the wafer W may be initiated without rotation of the chuck, or after the chuck 32 (132) is driven into rotation with the require speed which may be, e.g., in the range of 1 rpm to 60 rpm. Treatment is carried out by supplying the mixture of the organic-medium vapor with nitrogen to the exposed surface of the wafer W through the shower head 46 (146). In the embodiment of FIG. 3, the mixture of the organic-medium vapor with nitrogen is prepared in the vapor-nitrogen mixture generator 38, while in the embodiment of FIG. 4 the aforementioned mixture is prepared in the shower head 146. All given temperatures are controlled by respective controllers 37, 71 (137 and 171) through the temperature sensors 36, 44 (136, 144), and others which are not shown.

It is understood that the temperatures of the wafer W and the organic medium are selected so as to satisfy the above-described conditions required for the softening of the surfaces of the pattern line edges to the extent that the rough edges can be smoothened by the forces of surface tension without distorting the outlines and shapes of the pattern lines.

As has been mentioned above, in the case of the embodiment of the apparatus 120 (FIG. 5) with the diffuser of the type shown in FIG. 4, the apparatus 120 will be the same as the apparatus 20 of FIG. 3 and will operate in the same manner as described above, except that the apparatus 120 will not contain the vapor-nitrogen mixture generator 38, and the diffuser 151 of the type shown in FIG. 4 will be used instead and located in the shower head 146.

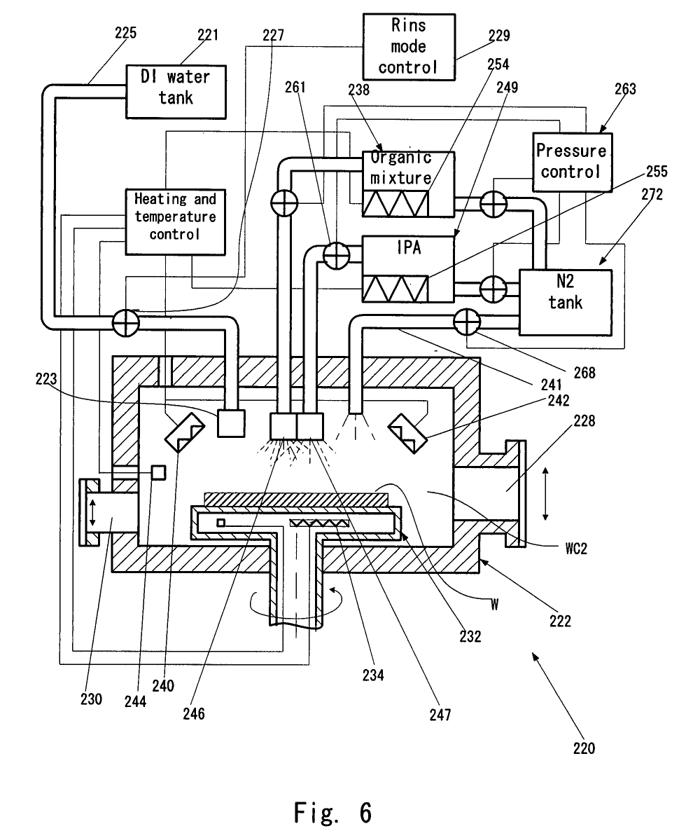

FIG. 6 is a schematic view of an apparatus of the invention in which LER process, rinsing, and drying are carried out in a single working chamber. Since in general this apparatus is similar to one shown in FIG. 5, the parts of the embodiment of FIG. 6 identical to those of the embodiment of FIG. 5 will be designated by the same reference numerals with an addition of 100 and their description will be omitted. Thus, in FIG. 6 the shower head is designated by reference numeral 246, the nitrogen tank is designated by reference numeral 272, etc. The working chamber of this apparatus is designated by WC2.

A main distinction of the apparatus of FIG. 6 from one shown and described with reference to FIG. 5 is that the apparatus of FIG. 6 is more universal and compact and incorporates in one working chamber WC2 a LER function, a function of rinsing with de-ionized water (DIW) and a function of drying with the use of isopropyl alcohol in a mixture with nitrogen.

More specifically, the apparatus 220 additionally incorporates a DIW supply system that consists of a DIW tank 221 that supplies DIW to the DIW spraying nozzle 223 through a supply tube 225 via an adjustable valve 227 controlled by a DIW supply controller 229. The spraying nozzle 223 is located in the working chamber WC2 directly above the wafer chuck 232.

In the embodiment of FIG. 6, the apparatus contains two separate shower heads, i.e., a shower head 246 for the supply of the mixture of the organic-medium vapor with nitrogen to the exposed surface of the wafer W, and a shower head 247 for the supply of an isopropyl-alcohol (IPA) mist and nitrogen onto the wafer for accelerated drying of the wafer after rinsing with the DIW. The drying is carried out in the same chamber WC2 by increasing the rotation speed of the wafer chuck 232 with the wafer W in it and supplying an isopropyl-alcohol (IPA) mist onto the wafer W from the top of the chamber WC2. After the IPA forms a solution with the residue of water on the wafer, the drying process is accelerated by supplying into the chamber WC2 gaseous nitrogen from N₂ tank 272 through the tube 241 . As a result, the IPA-water solution quickly evaporates without leaving traces of water drops on the dried surface. Reference numeral 255 designates an IPA heater.

The shower head 246 may be made without the diffuser shown in FIG. 4 or may contain such a diffuser. The pipe for the supply of nitrogen to the shower head 246 is not shown in FIG. 6 in order to simplify the drawing. The shower head 247 should preferably incorporate the diffuser of the type shown in FIG. 4. A separate pipe for the supply of nitrogen to the shower head 247 is not shown for simplicity of the drawing but it is assumed that it should be similar to the pipe 166 shown in FIG. 5.

It is understood that in the apparatus 220 of FIG. 6 the steps of softening, rinsing, and drying being carried out without changing the position of the wafer W in said wafer chuck 232.

It was shown that according to the invention the organic substance may be used in a phase selected from vapor or mist.

Furthermore, it was shown that the invention provides a method and an apparatus for smoothening rough edges of lithographic patterns by softening the material of the edges to a degree that allows smoothening under effect of surface tension. The invention makes it possible to improve quality of the pattern elements without deviation from the designed contours and dimensions of the pattern lines. The process is not subject to segregation effects, does not involve a large amount of chemicals, is easy to control, is versatile, has sufficient flexibility, and is not associated with the formation of liquid films known to induce mechanical pattern damage. The aforementioned method and apparatus do not need the use of vacuum and associated complicated equipment. One embodiment of the apparatus provides LER treatment, rinsing, and drying in a single working chamber.

Although the invention has been shown and described with reference to specific embodiments, it is understood that these embodiments should not be construed as limiting the areas of application of the invention and that any changes and modifications are possible, provided that these changes and modifications do not depart from the scope of the attached patent claims. For example, the volatile liquids other than IPA and neutral gases other than nitrogen can be used for the drying process performed in the apparatus. Organic solutions other than those mentioned in the specification can be used for interaction with the material of the resist. The resists themselves can be made from different materials. The mist/aerosole of the organic liquid and/or mist of IPA with nitrogen may be formed not necessarily in the shower head but may be formed outside the working chamber and injected into the working chamber. Any other modifications and changes are possible provided that the main principle of the invention consisting of softening of the material of rough edges to the degree that allows smoothening by surface tension is observed.

1. A method of smoothening edges of lithographic patterns having roughness on the aforementioned edges and made from a pattern material, the method comprising the steps of: providing a source of a neutral gas; providing a source of a organic substance which is compatible with the pattern material and is capable of interacting with the surface of the aforementioned lithographic pattern and softening said surface; creating a phase of the aforementioned organic substance selected from vapor and mist; mixing said phase of the aforementioned organic substance with the aforementioned neutral gas for forming a mixture of the neutral gas with said phase of the organic substance; heating the surface of the lithographic pattern to a temperature substantially equal to the temperature of the vapor of the aforementioned organic substance; softening the surface of the aforementioned lithographic pattern by exposing this surface to the aforementioned mixture; and smoothening said roughness due to forces of surface tension developed in the surface subjected to softening.

2. The method of claim 1, wherein softening of the surface of the lithographic pattern is carried out under pressure substantially equal to atmospheric.

3. The method of claim 1, wherein softening of the surface of the lithographic pattern is carried out under pressure slightly higher than the atmospheric pressure.

4. The method of claim 2, wherein the surface of the lithographic pattern is maintained at a temperature that provides diffusion of the organic substance into the surface of the lithographic pattern.

5. The method of claim 4, wherein diffusion is carried out under conditions selected from direct diffusion and diffusion after condensation of the organic substance on the surface of the lithographic pattern.

6. The method of claim 5, wherein in order to prevent condensation of the vapor and create conditions for forming a thin film of the organic substance on the aforementioned surface that stretches the roughness due to the forces of surface tension the surface of the lithographic pattern is maintained at a temperature 3-10° C. higher than the temperature of the vapor.

7. The method of claim 1, further comprising the step of adjusting the flow rate of the mixture of the neutral gas with said phase of the organic substance.

8. The method of claim 7, wherein the mixture of the neutral gas with said phase of the organic substance is supplied to said surface in a mode selected from a continuous flow and a pulsed flow.

9. The method of claim 8, further comprising the step of adjusting temperature and pressure of said phase of the organic substance.

10. The method of claim 5, further including the step of adjusting the flow rate of the mixture of the neutral gas with said phase of the organic substance.

11. The method of claim 10, wherein the mixture of the neutral gas with said phase of the organic substance is supplied to said surface in a mode selected from a continuous flow and a pulsed flow.

12. The method of claim 11, further comprising the step of adjusting temperature and pressure of said phase of the organic substance.

13. The method of claim 1, wherein said pattern is formed on a semiconductor wafer, said method being carried out in an apparatus having a wafer chuck, said semiconductor wafer being held in said wafer chuck, said method further comprising the step of rinsing said surface after said step of softening, and drying said surface after the step of rinsing, said steps of softening, rinsing, and drying being carried out without changing the position of the wafer in said wafer chuck.

14. The method of claim 13, further comprising the step of preparing a mist of gaseous nitrogen in a mixture with a vapor of isopropyl alcohol, and using said mist for drying said wafer after the step of rinsing.

15. The method of claim 1, wherein the aforementioned organic substance is selected from the group consisting of propylene glycol monomethyl ether acetate, ethyl 2-methylbutenoate, ethyl 2-butenoate, and ethyl 3-methylbutanoate.

16. The method of claim 5, wherein the aforementioned organic substance is selected from the group consisting of propylene glycol monomethyl ether acetate, ethyl 2-methylbutenoate, ethyl 2-butenoate, and ethyl 3-methylbutanoate.

17. An apparatus for smoothening rough edges of lithographic patterns having roughness on the aforementioned edges and made from a pattern material on a semiconductor wafer, said apparatus comprising:
means for softening the edges to the condition of smoothening thereof under the effect of surface tension.

18. The apparatus of claim 17, comprising a housing that has an interior that forms a working chamber and that is provided with an inlet port for loading/unloading of semiconductor wafer, a gas exhaust port, and a wafer chuck;
a source of supply of a neutral gas into said interior of the working chamber;
a source of a liquid medium capable of interacting with the pattern material for softening thereof;
said means for softening the edges to the condition of smoothening thereof under the effect of surface tension comprising:
a unit for creating a vapor of the aforementioned liquid medium, wherein the unit for creating a vapor of the aforementioned liquid medium comprises a container with the aforementioned liquid medium, a heater for heating the liquid medium in the container to the temperature close to boiling point thereof, a pipe that connect the aforementioned source of neutral gas to said container below the level of the liquid medium in the container for creating a mixture of the vapor with the neutral gas; a controller for controlling the temperature of the liquid medium; an adjustable valve for passing the mixture of the vapor with the neutral gas to the working chamber; and a controller for controlling the operation of the adjustable valve.

19. The apparatus of claim 17, comprising a housing that has an interior that forms a working chamber and that is provided with an inlet port for loading/unloading of semiconductor wafer, a gas exhaust port, and a wafer chuck;
a source of supply of a neutral gas into said interior of the working chamber;
a source of a liquid medium capable of interacting with the pattern material for softening thereof;
said means for softening the edges to the condition of smoothening thereof under the effect of surface tension comprising:
wherein the unit for creating said mist/aerosol comprises a container with the aforementioned liquid medium, a heater for heating the liquid medium in the container to the temperature close to boiling point thereof, a diffuser for creating a mist/aerosol of the aforementioned liquid medium with neutral gas, a source of supply of a neutral gas to said diffuser, a controller for controlling the temperature of the liquid medium, an adjustable valve for passing the liquid medium to the working chamber; and a controller for controlling the operation of the adjustable valve.

20. The apparatus of claim 19, further comprising a shower head located in said working chamber above the wafer chuck, the aforementioned diffuser being located in the shower head, and wherein neutral gas is nitrogen.

21. The apparatus of claim 17, further comprising a wafer rinsing unit and a wafer drying unit which are located in the same working chamber as said means for softening the edges.

22. The apparatus of claim 21, wherein the means for softening the edges to the condition of smoothening thereof under the effect of surface tension comprising:
a unit for creating a vapor of the aforementioned liquid medium, wherein the unit for creating a vapor of the aforementioned liquid medium comprises a container with the aforementioned liquid medium, a heater for heating the liquid medium in the container to the temperature close to boiling point thereof, a pipe that connect the aforementioned source of neutral gas to said container below the level of the liquid medium in the container for creating a mixture of the vapor with the neutral gas; a controller for controlling the temperature of the liquid medium; an adjustable valve for passing the mixture of the vapor with the neutral gas to the working chamber; and a controller for controlling the operation of the adjustable valve.

23. The apparatus of claim 22, wherein the wafer drying unit comprises a source of isopropyl alcohol, a container for holding isopropyl alcohol obtained from the source of isopropyl alcohol, a source for the supply of neutral gas into the aforementioned isopropyl alcohol in order to form a mixture of isopropyl alcohol with nitrogen, and a shower head for directing the aforementioned mixture onto the wafer after rinsing.
